(19) United States
(12) Patent Application Publication
(10) Pub. No.: US 2009/0296589 A1
(43) Pub. Date: Dec. 3, 2009

(54) METHOD AND APPARATUS OF MEASURING TCP NETWORK ROUND TRIP TIME

(76) Inventors: Dan Prescott, Elbert, CO (US); Douglas M. Roberts, McDonough, GA (US)

Correspondence Address: PATENTTM.US, P. O. BOX 82788, PORTLAND, OR, 97282-0788, US

(21) Appl. No.: 12/129,340

(22) Filed: May 29, 2008

(51) Int. Cl. H04L 12/26

(52) U.S. Cl. 370/249; 370/252

(57) ABSTRACT

Network round trip time is measured as an initial value at a start of a network communication flow. If sufficient data is available subsequently during a communication flow, subsequent network round trip time value determinations are made, without TCP stack overhead and time out values being included in the determined value.

### BACKGROUND OF THE INVENTION

This invention relates to networking, and more particularly to determination of network round trip time in a TCP network in the monitoring and analysis of network traffic.

In a computer networking environment, users may install and deploy monitoring and/or troubleshooting tools for observation of network traffic and network installation and maintenance. The TCP protocol provides a reliable transport mechanism between two machines on a network. It is useful to be able to accurately measure the time required for packets to make a round trip from one machine to the other.

Currently, one accurate measurement of round trip time is obtainable at the start of the socket connection, and the opportunity to take subsequent measurements exists throughout the life of the socket. However, the biggest issue in the subsequent measurements, as currently implemented, is that the TCP stack overhead and timeout values are included in the value that is reported as network round trip time, and this is not desirable as it results in an inaccurate reported value.

Other protocol analysis tools present network round trip time as an average of initial and subsequent measurements, which is also a less accurate measurement of network round trip time.

These issues can result in an incorrect or inaccurate reporting of TCP network round trip time, which does not present a true indication of network performance.

### SUMMARY OF THE INVENTION

In accordance with the invention, advantage is take of both an initial network round trip time measurement and also accurate subsequent measurements of network round trip time are made only when there is enough data to ensure the measurement is accurate.

In accordance with the invention, improved measurement and reporting of network round trip time is provided.

Accordingly, it is an object of the present invention to provide an improved network analysis that determines network round trip time.

It is a further object of the present invention to provide an improved network monitoring device that measures and reports network round trip time.

It is yet another object of the present invention to provide improved methods of network monitoring and analysis to measure and report network round trip time.

Another object of the invention is to provide an improved method and apparatus for more accurate determination of network round trip time without inclusion of TCP stack overhead and timeout values.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a network with a network analysis product interfaced therewith;

FIG. 2 is a block diagram of a monitor device for measurement and reporting of network round trip time;

FIG. 3 is a flow diagram illustrating the network round trip time analysis to determine initial and subsequent network round trip time; and

FIG. 4 is a flow chart of determination steps.

### DETAILED DESCRIPTION

The system according to a preferred embodiment of the present invention comprises a monitoring system and method and an analysis system and method for determining and reporting network round trip time.

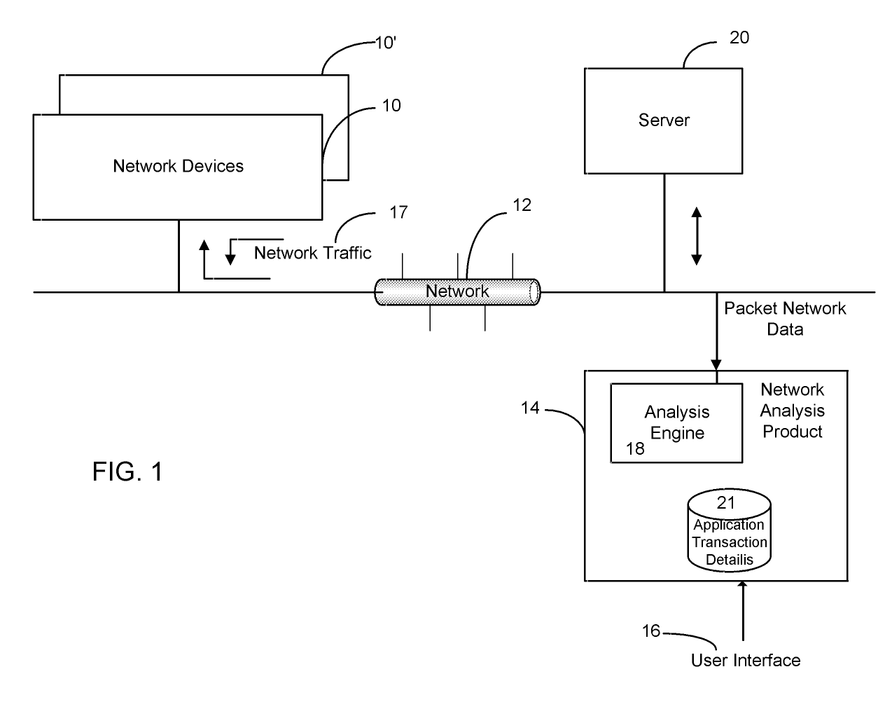

Referring to FIG. 1, a block diagram of a network with an apparatus in accordance with the disclosure herein, a network may comprise plural network devices 10, 10′, etc., which communicate over a network 12 by sending and receiving network traffic 17. The traffic may be sent in packet form, with varying protocols and formatting thereof.

A network analysis product 14 is also connected to the network, and may include a user interface 16 that enables a user to interact with the network analysis product to operate the analysis product and obtain data therefrom, whether at the location of installation or remotely from the physical location of the analysis product network attachment.

The network analysis product comprises hardware and software, CPU, memory, interfaces and the like to operate to connect to and monitor traffic on the network, as well as performing various testing and measurement operations, transmitting and receiving data and the like. When remote, the network analysis product typically is operated by running on a computer or workstation interfaced with the network.

The analysis product comprises an analysis engine 18 which receives the packet network data and interfaces with application transaction details data store 21.

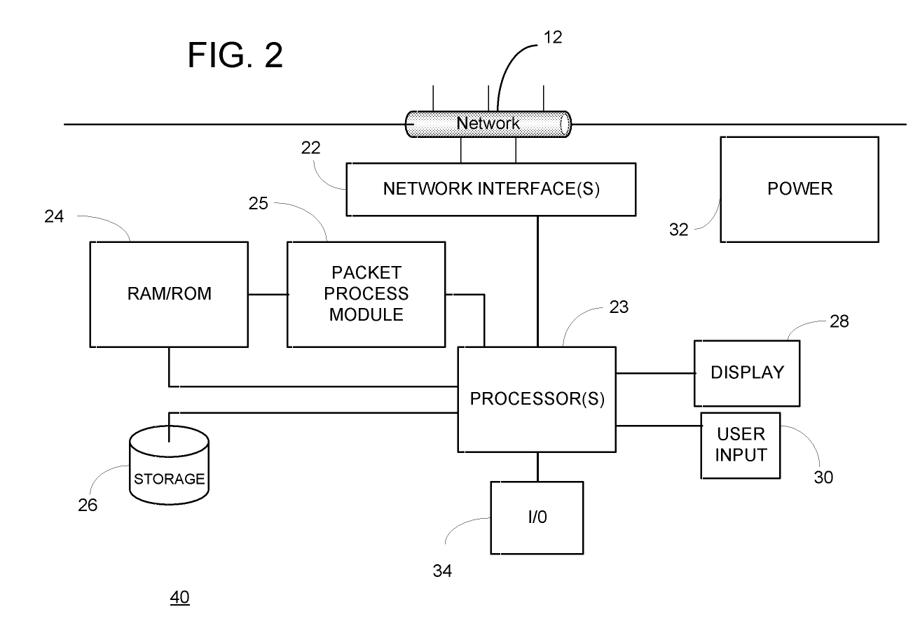

FIG. 2 is a block diagram of a test instrument/analyzer 40 via which the invention can be implemented, wherein the instrument may include network interfaces 22 which attach the device to a network 12 via multiple ports, one or more processors 23 for operating the instrument, memory such as RAM/ROM 24 or persistent storage 26, display 28, user input devices 30 (such as, for example, keyboard, mouse or other pointing devices, touch screen, etc.), power supply 32 which may include battery or AC power supplies, other interface 34 which attaches the device to a network or other external devices (storage, other computer, etc.). Packet processing module 25 provides processing of packets and storage of data related thereto for use in the analysis product to assist in the measuring and reporting of network round trip time, as discussed further herein.

In operation, the network test instrument is attached to the network, and observes transmissions on the network to collect statistics thereon and to determine initial and subsequent network round trip time.

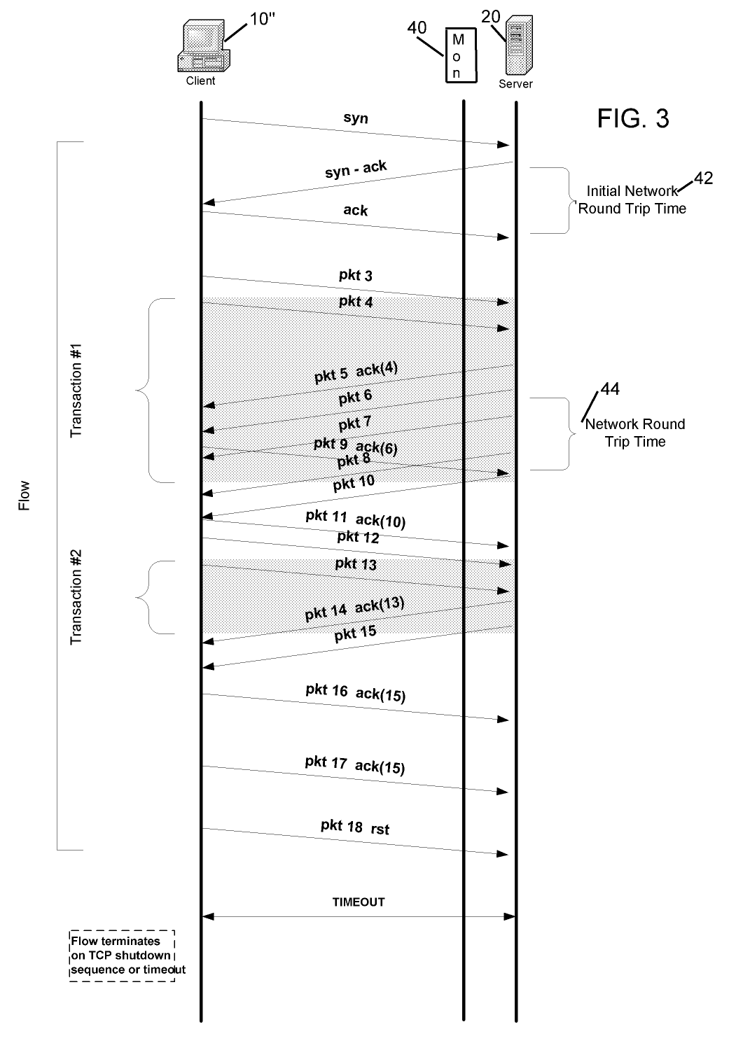

FIG. 3 is a flow diagram illustrating the environment and operation of the invention. Client 10″ and server 20 are illustrated with the space therebetween illustrating the network and traffic. Monitor device 40 is illustrated as observing network traffic at a position on the network. In the illustrated example 2 TCP transactions are shown with initial network round trip time and a subsequent network round trip time value being determined. All these transactions are observed by the monitor 40, which suitably performs the measurement and analysis for network round trip time. Communication between client 10″ and server 20 begins with a syn/syn-ack/ack handshake between client and server, to establish the start of a TCP. The time between server 20 sending the syn-ack and the return ack from client 10″ is then determined to be the initial network round trip time value 42. Client 10″ then sends packets pkt3 and pkt4, and server 20 then sends pkt5 (an ack from the server of pkt4 from the client) and pkt6, pkt7 and pkt8. Client 10″ sends pkt9, which is an ack of pkt6, before receipt of pkt7 at the client. Monitor 40, observing from a server side of the operation, notes that pkt9 is an ack of a packet where a first data packet (pkt5) in the sequence of communication from server 40 to client 10″ was not acknowledged by the client but second packet in the sequence (pkt6) was acknowledged. Accordingly, the time between pkt6 being sent and pkt9 being received is determined to be a subsequent network round trip time value 44.

This subsequent value can be used as an updated value to report a more current network round trip time. If, however, the criteria never occur during a period of observation, of noting a second packet in a sequence being acked when a first packet was not acked, then the initial network round trip value may be retained as the closest possible determination of network round trip value for a given transaction.

The analysis of the network data to determine network round trip time may be made based on the traffic as observed in real time or near real time, or may be made based on data stored in application transactions details 21 as a post processing analysis of data collected over a period of time.

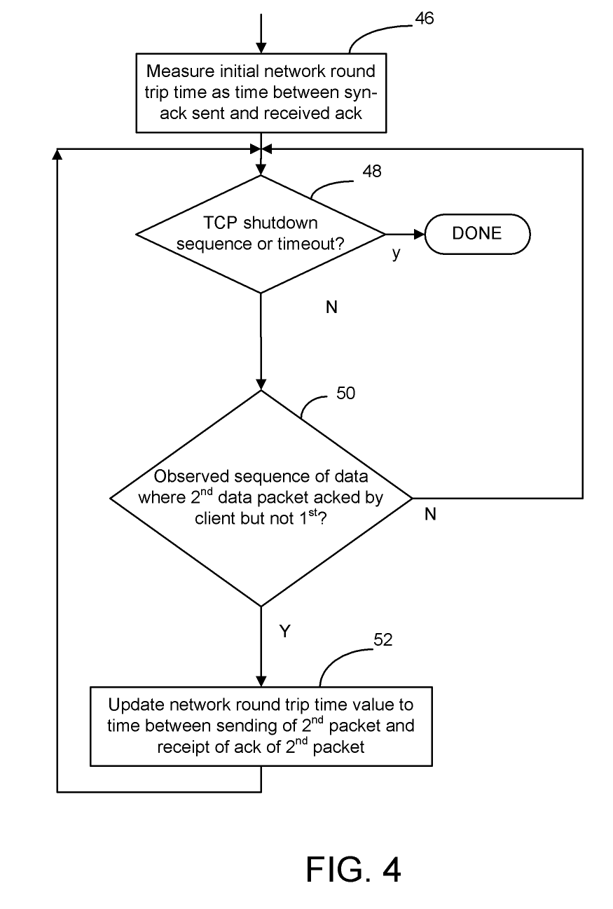

FIG. 4 is a flow chart of the analysis process in analyzing observed network traffic data from real time or from the application transaction detail data store. In block 46, the initial network round trip time is measured as the time between the server sending syn-ack and the server receiving the corresponding ack from the client.

Decision block 48 checks whether the flow is complete due to a TCP shutdown sequence or timeout, in which case, no further processing is required.

If flow is not complete, then decision block 50 determines whether a second data packet has been observed and acked where the first packet was not acked. If not, processing continues back to decision block 48.

If the result of decision block 50 is yes, then in block 52 network round trip time is updated with a more current value by determining the time between the sever sending the 2^{nd} packet and the receipt of the ack from the client of the 2^{nd} packet. Processing continues back to decision block 48.

If the criteria are not met of a first data packet in a sequence not being acknowledged and a second data packet in the sequence being acknowledged, then the initial network round trip value is retained as the closest representation of network round trip available for the transaction.

The network round trip time values may be stored and reported with information regarding which client and which server was involved, for example, with further information that may be of assistance to the user.

The network round trip time analysis may be implemented as a part of a network test instrument, or may be separately provided to process data gathered by a network test instrument.

In accordance with the above, the invention provides an more accurate network round trip time value, that is not affected by TCP stack overhead and timeout values.

While the illustrated example shows the analysis as made from the view of the server, the network round trip time determination may also be made anywhere else in the network. For example, if the determination is made from the client side view, with the initial network round trip time determination based on, for example, the time between the client sending the syn and the receipt of the syn-ack from the server, and subsequent network round trip time values being determined from an ordered sequence of client to server data packets such that the first data packet in the sequence is not acknowledged by the server and the second data packet in the sequence is acknowledged by the server.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method of determining network round trip time, comprising:
making an initial network round trip time determination; and
if sufficient data is available, making a subsequent network round trip time determination.

2. The method according to claim 1, wherein said initial network round trip time determination is a time between observation of a communication handshake acknowledgement from a first side of communication and observation of a corresponding acknowledgment from a second side of communication.

3. The method according to claim 1, wherein whether sufficient data is available is determined when,
an acknowledgement of a packet where a first data packet in a sequence of communication was not acknowledged but a second packet in the sequence of communication was acknowledged.

4. The method according to claim 3, wherein said subsequent network round trip time determination is a time between observation of said second data packet and observation of acknowledgment of said second data packet.

5. The method according to claim 1, wherein said subsequent network round trip time determination is made without inclusion of stack overhead or timeout values being included.

6. A network test instrument for determining network round trip time, comprising:
an initial network round trip time determination system; and
a subsequent network round trip time determination system, for determining subsequent network round trip time when sufficient data is available for determining subsequent network round trip time.

7. The network test instrument according to claim 6, wherein said initial network round trip time determination system measures a time between observation of a communication handshake acknowledgement from a first side of communication and observation of a corresponding acknowledgment from a second side of communication.

8. The network test instrument according to claim 6, wherein said subsequent round trip determination system determines whether sufficient data is available is determined when,
an acknowledgement of a packet where a first data packet in a sequence of communication was not acknowledged but a second packet in the sequence of communication was acknowledged.

9. The network test instrument according to claim 8, wherein said subsequent network round trip time determination system determination is a time between observation of said second data packet and observation of acknowledgment of said second data packet.

10. The network test instrument according to claim 6, wherein said subsequent network round trip time determination is made without inclusion of stack overhead or timeout values being included.

11. A network round trip time determination system, comprising:
a network interface for observing network traffic;
a network data processing module for determining network packet acknowledgment and sequence numbers;
a decision processor for determining an initial network round trip time value and for determining subsequent network round trip time values when sufficient data is available to make a subsequent network round trip time determination.

12. The system according to claim 11, wherein said initial network round trip time determination is a time between observation of a communication handshake acknowledgement from a first side of communication and observation of a corresponding acknowledgment from a second side of communication.

13. The system according to claim 11, wherein whether sufficient data is available for a subsequent network round trip time determination is determined when,
an acknowledgement of a packet is observed where a first data packet in a sequence of communication was not acknowledged but a second packet in the sequence of communication was acknowledged.

14. The system according to claim 13, wherein said subsequent network round trip time determination is a time between observation of said second data packet and observation of acknowledgment of said second data packet.

15. The system according to claim 11, wherein said subsequent network round trip time determination is made without inclusion of stack overhead or timeout values being included.
